(19) United States
(12) Patent Application Publication
(10) Pub. No.: US 2014/0074859 A1
(43) Pub. Date: Mar. 13, 2014

(54) SYSTEM AND METHOD FOR RATING AUDIENCES OF NETWORK-BASED CONTENT OF MULTIPLE CONTENT PUBLISHERS

(71) Applicants: Viswanathan Swaminathan, Saratoga, CA (US); Herman S. Sahota, San Jose, CA (US)

(72) Inventors: Viswanathan Swaminathan, Saratoga, CA (US); Herman S. Sahota, San Jose, CA (US)

(21) Appl. No.: 13/608,820

(22) Filed: Sep. 10, 2012

(51) Int. Cl. G06F 17/30

(52) U.S. Cl. 707/748; 707/E17.009

(57) ABSTRACT

Embodiments of a system and method for rating audiences of network-based content of multiple content publishers are described. Embodiments may include, for each of multiple users, receiving usage information specifying one or more attributes of the user's content consumption activity with respect to network-based content. The usage information received for at least some of the users may be associated with network-based content from multiple different content publishers (e.g., different websites that host content portals). Embodiments may also include determining a subset of the multiple users that share one or more characteristics (e.g., demographic characteristics). Embodiments may also include generating a report based on a portion of the received usage information that is specific to the subset of the multiple users. The report may specify one or more aggregate attributes of the subset's content consumption activity.

### BACKGROUND

Audience measurement systems are used to gain information about the popularity of media content. For instance, a component of a set top box (e.g., a “cable box”) may capture the viewing habits of individuals that watch television programming on a television that is connected to the set top box. This information may be aggregated for many different households to gain insight into the popularity of different television programming. The aggregated information may be used for advertising purposes, such as pricing advertising spots (e.g., commercials) that are sold to advertisers. For instance, a commercial spot during very popular television programming (e.g., programming expected to draw a large number of viewers) may be priced higher than a commercial spot during less popular television programming. Similar audience measurement systems may also be implemented for internet-based content.

### SUMMARY

Various embodiments of a system and method for rating audiences of network-based content of multiple content publishers are described. Embodiments may include, for each of multiple users, receiving usage information specifying one or more attributes of the user's content consumption activity with respect to network-based content. The usage information received for at least some of the users may be associated with network-based content from multiple different content publishers (e.g., different websites that host content portals). Embodiments may also include determining a subset of the multiple users that share one or more characteristics (e.g., demographic characteristics). Embodiments may also include generating a report based on a portion of the received usage information that is specific to the subset of the multiple users. The report may specify one or more aggregate attributes of the subset's content consumption activity.

In various embodiments, use of tracking data in multiple domains (e.g., publisher domains and ratings server domains) may enable a user to opt-in once for a given ratings entity and have their content consumption activities tracked across multiple publishers. For instance, when a user uses client system to visit a content publisher's site for the first time, there may not yet be tracking data for that publisher on the client system. However, the user (and any records of user or usage data) may be identified by the ratings server based on a user identifier from client tracking data associated with that ratings server. This may not only serve as a convenience feature for the user (e.g., since the user does not have to opt-in multiple times for different content publishers), but may also enable a single ratings entity to monitor the content consumption activity of a given user across multiple publisher sites. When defining an audience and generating a report for that audience, having data spanning multiple content publishers may provide a more comprehensive and/or accurate view of that audience's content consumption habits. This information may be utilized by advertisers to select the content in which to place advertisements for a targeted audience. In various embodiments, utilizing a third party ratings server may also cause users to be more forthcoming with user information. For instance, there may be some users that do not trust content publishers; however, such users may trust an independent third party ratings service.

### BRIEF DESCRIPTION OF THE DRAWINGS

FIG. 1 illustrates block diagram of an example system configuration including a ratings server(s), a content publisher system(s), and a client system, according to some embodiments.

FIG. 2 illustrates a flow diagram for communications between a ratings server(s), a content publisher system(s), and a client system, according to some embodiments.

FIG. 3 illustrates a flowchart of an example method for determining whether tracking of content consumption is to be performed on a client, according to some embodiments.

FIG. 4 illustrates a flowchart of an example method for handling opt-ins and opt-outs as well as collecting user and usage information, according to some embodiments.

FIG. 5 illustrates a flowchart of an example method for generating a report for a specific audience, according to some embodiments.

FIG. 6 illustrates an example computer system suitable for implementing various components of the system and method for rating audiences of network-based content of multiple content publishers, according to various embodiments.

While the system and method for rating audiences of network-based content of multiple content publishers is described herein by way of example for several embodiments and illustrative drawings, those skilled in the art will recognize that the system and method for rating audiences of network-based content of multiple content publishers is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the system and method for rating audiences of network-based content of multiple content publishers as defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Various embodiments of a system and method for rating audiences of network-based content of multiple content publishers are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from a software program. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Various portions of this detailed description may refer to “client(s)” and “server(s)” or similar terminology. For instance, various embodiments may include (among other elements) a client system or client device (or simply a “client”). It should be understood that the terms “client” and “server” do not impose any limitation on the operation, configuration, or implementation of such elements. It should be understood that these terms are used only as convenient nomenclature. Indeed, various embodiments are need not be limited by the principles of a conventional client-server architecture.

In various instances, this detailed description may refer to content items (which may also be referred to as “content,” “content data,” “content information” or simply “data” or “information”). In some instances, content items may include any information or data that may be licensed to one or more individuals (or other entities, such as business or group). In various embodiments, content may include electronic representations of video, audio, text and/or graphics, which may include but is not limited to electronic representations of videos, movies, or other multimedia, which may include but is not limited to data files adhering to Adobe® Flash® Video (.FLV) format or some other video file format whether such format is presently known or developed in the future. In various embodiments, the content items described herein may include electronic representations of music, spoken words, or other audio, which may include but is not limited to data files adhering to the MPEG-1 Audio Layer 3 (.MP3) format, Adobe® Sound Document (.ASND) format or some other format configured to store electronic audio whether such format is presently known or developed in the future. In some cases, content may include data files adhering to the following formats: Portable Document Format (.PDF), Electronic Publication (.EPUB) format created by the International Digital Publishing Forum (IDPF), JPEG (.JPG) format, Portable Network Graphics (.PNG) format, Adobe® Photoshop® (.PSD) format or some other format for electronically storing text, graphics and/or other information whether such format is presently known or developed in the future. In some embodiments, content items may include any combination of the above-described examples.

In various instances, this detailed disclosure may refer to consuming content or to the consumption of content, which may also be referred to as “accessing” content, “viewing” content, “listening” to content, or “playing” content, among other things. In some cases, the particular term utilized may be dependent on the context in which it is used. For example, consuming video may also be referred to as viewing or playing the video. In another example, consuming audio may also be referred to as listening to or playing the audio.

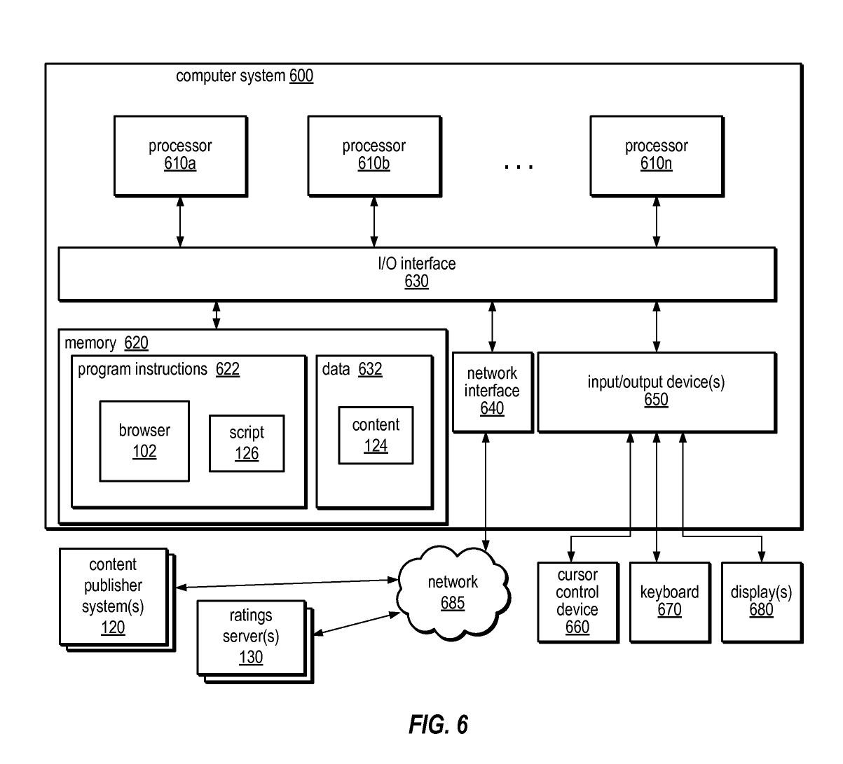

In various instances, this detailed description may refer to a devices configured to perform content consumption, such as client system 100. In various embodiments, such a device may include but is not limited to a computing system (e.g., a desktop or laptop computer), a set-top television box, a digital audio or multimedia player (e.g., an MP3 player), a personal digital assistant (PDA), a mobile phone, a smartphone, a touchscreen phone, an e-book reader, a digital photo frame, or any other device or system configured to access, view, read, write, and/or manipulate any of the content data described herein. Any of such devices may be implemented via a computer system similar to that described with respect to FIG. 6.

Note that in various instances the description presented herein may refer to a given entity performing some action. It should be understood that this language may in some cases mean that a system (e.g., a computer) owned and/or controlled by the given entity is actually performing the action.

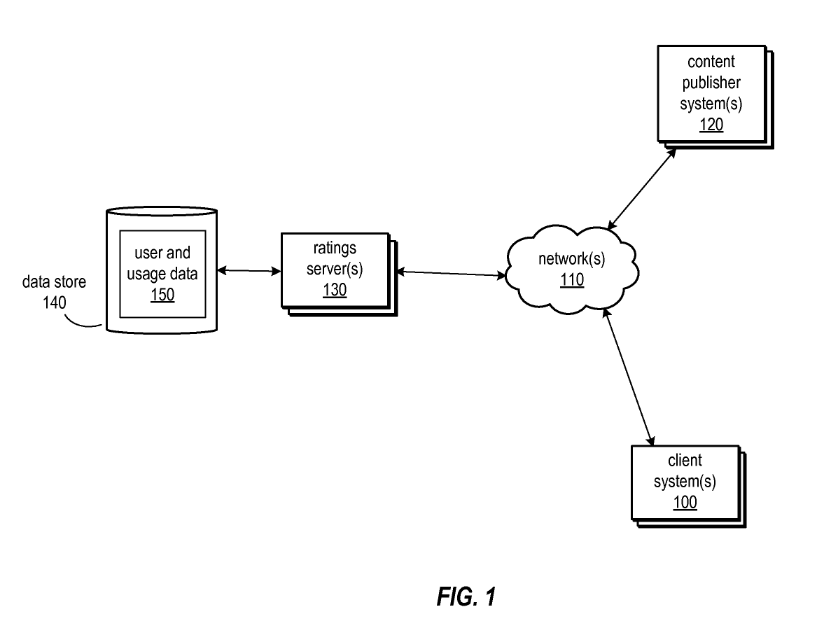

FIG. 1 illustrates a block diagram of an example system configuration in which a ratings server(s), a content publisher system(s), and a client system(s) may communicate with each another. In the illustrated embodiment one or more client systems 100 may access content from content publisher system(s) 120. For instance, a client system 100 may download (e.g., a streaming download) and/or consume video content (e.g., streaming video) from content publisher system(s) over one or more networks 110. Network(s) 110 may include but are not limited to wide area networks (WANs) (e.g., the internet), local area networks (LANs) (e.g., corporate or Ethernet networks), wireless networks, wired networks, other types of networks for electronically conveying information between computers or devices, or some combination thereof. In various embodiments, client system(s) 100 may be any electronic device configured to consume content including but not limited to desktop computers, laptop computers, smartphones, tablets, digital set top boxes, or media players. In various embodiments, a given client system may be implemented by a computer system, such as that of FIG. 6 described below.

In various embodiments, different content publishers may operate different content publisher system(s) to provide content to clients. In some cases, content publishers may focus on providing content that is different than content provided by other content publishers. For instance, one content publisher might provide video content associated with sports and another might be focused on providing full length movies or films. In some cases, a given publisher may provide an assortment of content spanning different categories. In some embodiments, the same content may be provided by different content publishers; for instance, two publishers may provide access to internet streaming versions of a television series. In various embodiments, some publishers may charge subscription fees for access to content whereas other publishers may provide free access to content supplemented with advertisements within or proximate to content. In some cases, a publisher may provide a mix of subscription fee based content and fee free ad-supported content.

The one or more ratings server(s) 130 may collect demographic information or other information about users of client system(s) 110 and/or usage information about the content accessed by client system(s) 110. In various embodiments, ratings server(s) 130 may collect such information for users that have opted-in to having their information collected. This user information and/or usage information may be stored in a data store 140 as user and usage data 150. Ratings server(s) 130 may implement an independent ratings service that is distinct from the content publishers described herein. Any acts or functionality described herein with respect to ratings server(s) 130 may be considered part of the independent ratings service according to various embodiments.

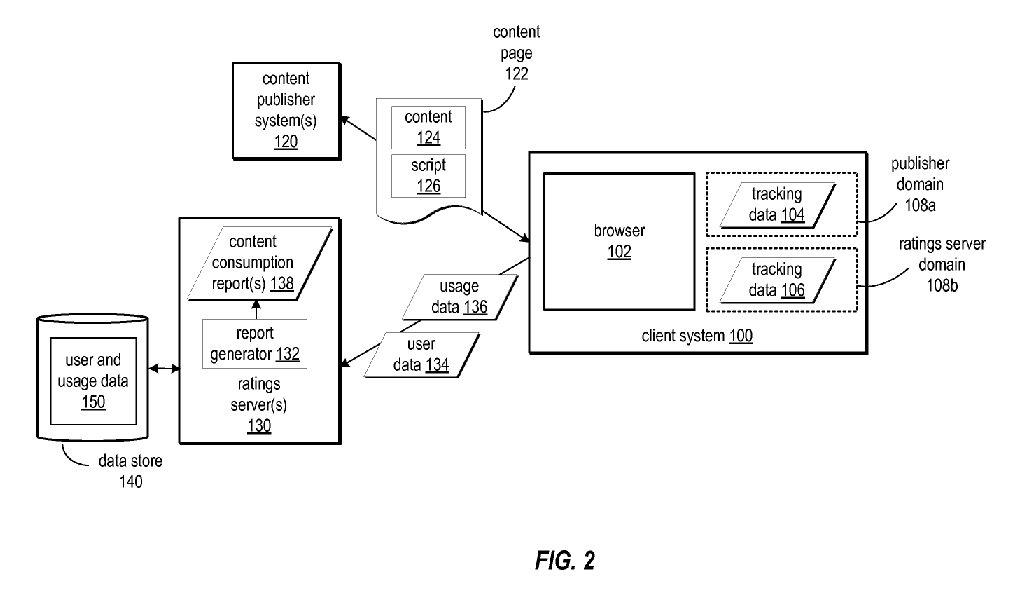

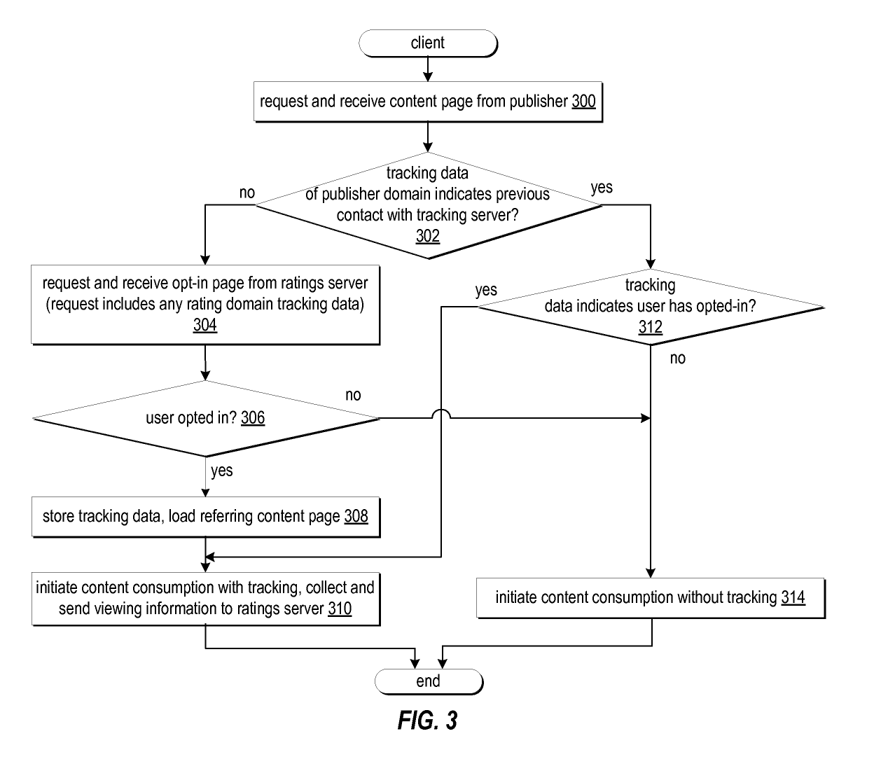

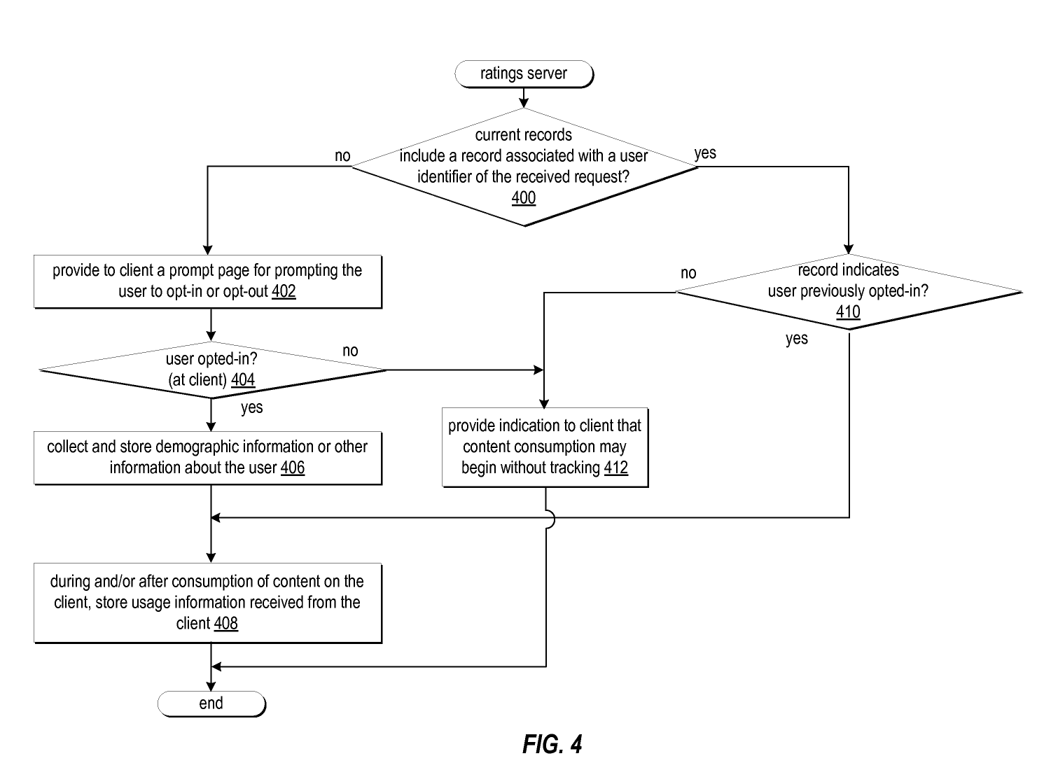

FIG. 2 illustrates a flow diagram for a client's content acquisition as well as a ratings server's acquisition of user data and usage data from a client. In the illustrated embodiment of FIG. 2, it will be assumed that the user of client system 100 has opted-in to having their user and usage information tracked by ratings server 130. In various embodiments, a user may opt-out of such tracking; such a scenario is described in more detail below with respect to FIGS. 3 and 4. In the illustrated embodiment, client system 100 may request and receive a content page 122 (e.g., a network page including a content item) from a content publisher system 120. The content page may include content 124 (e.g., video content to be consumed on the client) and one or more instructions that may be executed on the client to perform tracking related functions. These instructions are illustrated as script 126; although it should be noted that such instructions need not be limited to a script per se and may take on other forms, such as an executable application, extension, and/or browser plug-in. In various embodiments, browser 102 may be any application configured to interpret and/or render network based content on client system. For instance, content 124 may include a streaming web video that browser 102 may render on a display of client system 100 (either directly or through another application or plug-in, for example). In various embodiments, prior to consuming content 124, browser 102 may be configured to perform one or more actions specified by script 126 to determine which information, if any, is to be tracked regarding the user's content viewing habits on client system 100 (see e.g., FIG. 3 below).

Browser 102 may store tracking data (e.g., usage data) for different domains. For instance, tracking data 104 may correspond to tracking data associated with a specific publisher domain 108a, and tracking data 106 may correspond to tracking data associated with a specific ratings server domain 108b. In some embodiments, tracking data associated with a ratings server domain may not be used. Generally, browser 102 may maintain different tracking data (e.g., a cookie) for each content publisher system and ratings server encountered. In various embodiments, tracking data 104 may be present if the user has previously used client system 100 to access content from the publisher associated with publisher domain 108a. For instance, tracking data may represent a browser cookie (or other data) that indicates the user has previously received content from content publisher system 120 and opted-in (or out) of tracking services. Tracking data 106 may be a browser cookie (or other data) that indicates the user has previously communicated with ratings server 130. In various embodiments, this tracking data may include an identifier (e.g., a globally unique identifier) for the user of client system 100. In this way, the client system may maintain tracking data at the publisher level and the ratings server level. Furthermore, the presence of tracking data 106 may enable the ratings server to track the user's content consumption activities across multiple different publishers. For instance, the user identifier of tracking data 106 may be used to reference one or more records for the user at the ratings server. Use of tracking data 104 and 106 to determine whether to track the user's content consumption activities are described in more detail below with respect to FIGS. 3 and 4.

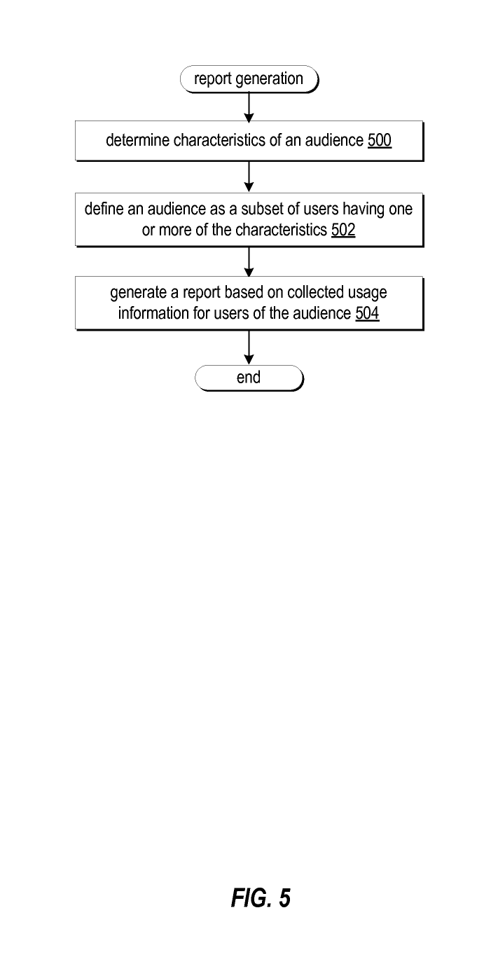

If it is determined that the user's content consumption activities are to be tracked (e.g., as described with respect to FIGS. 3 and 4), browser 102 may report user data (or user information) 134 and/or usage data (or usage information) 136 to the rating server. For instance, user data 134 may include demographic information or other information about the user. Generally this information is reported to the ratings server if the user has opted in to having their content consumption activities tracked. For example, this information may be provided from the client to the ratings server at opt-in time. Ratings server 130 may store such information in one or more records for the user within user and usage data 150 of data store 140. In various embodiments, these records may be associated with an identifier of the user for easy retrieval. For instance, all records for a specific user may be associated with a user's identifier, such as that of tracking data 106 described above. As ratings server 130 stores the user information for later use, this information need not be provided during content consumption that occurs subsequent to the user's initial opt-in. Although it should be understood that the user of the client may provide updated user data at their discretion and/or at the request of the ratings server. In various embodiments, user data 134 may include but is not limited to information about a user's age, gender, education level, location of residence, income, employment status, religion, marital status, ownership (e.g., home, car, etc.), and known languages. This information may be utilized by report generator 132 to generate reports for specific audiences, such as described below with respect to FIG. 5. In one non-limiting example, user data may be utilized to identify an audience of users that young adults living in urban areas. For instance, a report generated for this audience might specify the most popular web videos watched by young adults living in urban areas.

Usage information 136 may be sent from client system 100 to ratings server 130 for any user that has opted-in to having their content consumption activities tracked. Usage information may include but is not limited to an identifier of the content consumed, length of time the content was viewed, the specific portion of the content that was viewed, and the category or type of content viewed (e.g., drama, comedy, children's, action, etc.). In various embodiments, usage information may include usage characteristics for video data including but not limited to the duration that a video was played, the specific portion of the video that was watched (e.g., as denoted by a time range or range of frames), and any other characteristics about the video playback. Ratings server 130 may store usage information within user and usage data 150 of data store 140. In various embodiments, both user information and usage information may be associated with a user's identifier for easy reference at a later time (e.g., for report generation). This information may be utilized by report generator 132 to generate content consumption report(s) 138 for specific audiences, such as described below with respect to FIG. 5. For instance, user and usage data 150 may be stored in a structured format, such as a database or other query-able structured format.

In various embodiments, use of tracking data in multiple domains (e.g., publisher domains and ratings server domains) may enable a user to opt-in once for a given ratings entity and have their content consumption activities tracked across multiple publishers. For instance, when a user uses client system 100 to visit a content publisher's site for the first time, there may not yet be tracking data 104 for that publisher on the client system. However, the user (and any records of user or usage data) may be identified by the ratings server based on a user identifier from tracking data 106 associated with that ratings server. This may not only serve as a convenience feature for the user (e.g., since the user does not have to opt-in multiple times for different content publishers), but may also enable a single ratings entity to monitor the content consumption activity of a given user across multiple publisher sites. When defining an audience and generating a report (e.g., FIG. 5) for that audience, having data spanning multiple content publishers may provide a more comprehensive and/or accurate view of that audience's content consumption habits. This information may be utilized by advertisers to select the content in which to place advertisements for a targeted audience.

In various embodiments, utilizing a third party ratings server may also cause users to be more forthcoming with user information. For instance, there may be some users that do not trust content publishers; however, such users may trust an independent third party ratings service. In some cases, the ratings server(s) described herein may also provide anonymized storage of user information. For instance, users may be tracked by a global identifier (e.g., the identifier described above with respect to tracking data 106) instead of personally identifiable information (e.g., the user's name).

### Example Methods

Embodiments of the system and method for rating audiences of network-based content of multiple content publishers may include various methods performed by one or more computer systems or devices. FIGS. 3-5 illustrate examples of such methods. In various embodiments, the illustrated Figures may be implemented by components or systems described herein. In some embodiments, the methods described herein may be implemented on one or more computer systems, such as the computer system of FIG. 6 described below.

FIG. 3 illustrates a flowchart of an example method for determining whether tracking of content consumption is to be performed on a client. In various embodiments, the illustrated method may be performed by a client, such as client system 100 described above. In various embodiments, script 126 (described above) may specify instructions for performing the illustrated method. In one example, to perform the illustrated method, browser 102 of the client system may perform the method in accordance with the script.

As illustrated at block 300, the method may include requesting and/or receiving a content page from a publisher. For instance, the method may include receiving a web page including video content as one example. A browser 102 receiving content page 122, as described above, is also an example of this portion of the method.

As illustrated at block 302, the method may also include determining whether tracking data of the publisher domain indicates that the user and/or client system has had previous contact with the tracking server. For instance, as described above, the client system may include tracking data for both publisher domains and ratings server domains. The method may include locating the any local tracking data (e.g., cookies) for the publisher. If there is no tracking data for that publisher or the tracking data does not indicate previous contact has been made with the tracking server, the method may proceed to block 304, as indicated by the negative output of block 302.

At block 304, the method may include requesting and receiving the opt-in page from the rating server. This request may include any rating domain tracking data available. For instance, as described above, the ratings server domain may include tracking data (e.g., a cookie) that includes a user identifier, which may be utilized to identify the user's user information and/or usage information at the ratings server. If at block 306 it is determined the user has already opted in (e.g., as specified by the ratings server), the method may proceed to block 308. At block 308, the method may include storing tracking data and loading the referring content page. For instance, storing the tracking data may include storing a cookie in the publisher domain of the client. The tracking data may specify that the user has opted-in to having their content consumption activities tracked/monitored. Loading the referring content page may include accessing and rendering the original page previously visited in block 300. At block 310, the method may include initiating content consumption (e.g., video playback) with tracking enabled. For instance, during or after content consumption, usage information may be captured and sent to the ratings server. As described above, usage information may include but is not limited to an identifier of the content consumed, length of time the content was viewed, the specific portion of the content that was viewed, and the type of content viewed (e.g., drama, comedy, children's, action, etc.).

As illustrated by the positive output of block 302, if the tracking data (e.g., a browser cookie) of the publisher domain does indicate that the user of the client has made previous contact with the tracking server, the method may proceed to block 312. At block 312, the method may include determining whether the tracking data indicates the user has opted in to having their content consumption activities monitored or tracked. If the user has opted, the method may proceed to block 310 to initiate content consumption with tracking as described above. For instance, during or after content consumption, usage information may be captured and sent to the ratings server. If the tracking does not indicate the user has opted in, the method may proceed to block 314 in which case content consumption is initiated without tracking. In other words, usage information is not collected and sent to the ratings server for this instance of content consumption.

As described above, the client may request and receive an opt-in page from the ratings server (e.g., item 304 of FIG. 3); the request may include an identifier of the user that may be used by the ratings server to identify stored usage information and user information for the user. FIG. 4 illustrates a flowchart of an example method for processing such a request. In various embodiments, the illustrated method may be performed by one or more ratings servers implementing an independent ratings service, such as ratings server(s) 130 described above.

As illustrated at block 400, the method may include determining whether current records include a record associated with a user identifier of the received request, such as a client request for an opt-in page (see e.g., the request of block 304 of FIG. 3). For instance, this portion of the method may include searching a data store of user information and user information, such as data store 140 including user and usage data 150 described above. As illustrated by the positive output of block 400, if a record is found that matches the user's identifier, the method may proceed to block 410. At block 410, the method may include determining whether the record found in block 400 indicates that the user previously opted-in to having their content consumption activities tracked by the ratings server. As illustrated by the negative output of block 410, if the user has not previously opted-in to having their content consumption activities tracked by the ratings server, the method may include providing an indication to the client that content consumption may begin without tracking (block 412). The client may then initiate content consumption without tracking, such as described above with respect to block 314 of FIG. 3.

As illustrated by the positive output of block 410, if the user has previously opted-in to having their content consumption activities tracked by the ratings server, the method may proceed to block 408. At block 408, the method may include, during and/or after consumption of content on the client, storing usage information received from the client. For instance, as described above, usage information may include but is not limited to an identifier of the content consumed, length of time the content was consumed, the specific portion of the content that was consumed, and the type of content consumed (e.g., drama, comedy, children's, action, etc.). In some cases, user information (e.g., the demographic information described above) may also be received and stored at this time; although in many cases, this information may already be stored at the ratings server (e.g., user information received during he user's initial opt-in).

As illustrated by the negative output of block 400, if it is determined that the ratings server's records do not include a record associated with the user identifier of the received request, the method may include providing the client with data representing a prompt page for prompting the user to opt-in or opt-out. As illustrated by the negative output of block 404, if the user (client-side) did not opt-in to having their content consumption activities tracked/monitored, the method may proceed to block 412 including providing an indication to the client that content consumption may begin without tracking. The client may then initiate content consumption without tracking, such as described above with respect to block 314 of FIG. 3. As illustrated by the positive output of block 404, if the user (client-side) did opt-in to having their content consumption activities tracked/monitored, the method may proceed to block 406. At block 406, the method may include collecting and storing demographic information or other information about the user. For instance, demographic information may include but is not limited to information about a user's age, gender, education level, location of residence, income, employment status, religion, marital status, ownership (e.g., home, car, etc.), and known languages. This information may be utilized by report generator 132 to generate reports for specific audiences, such as described below with respect to FIG. 5. In one example, this portion of the method may include storing the collected information within one or more records associated with the user's identifier within user and usage data 150.

In various embodiments, the user need only go through the opt-in process once to have their content consumption activities tracked across multiple different content publisher sites. For instance, the client side tracking data or cookie that results from the opt-in process (see e.g., item 318 above) may be used to identify the user across multiple different content publisher sites. In this way the independent ratings service may track the content consumption activity of a user across multiple content publisher sites without inconveniencing the user with separate opt-in processes for each content publisher.

After block 406, the method may proceed to block 408, which may include, during and/or after consumption of content on the client, storing usage information received from the client. For instance, as described above, usage information may include but is not limited to an identifier of the content consumed, length of time the content was consumed, the specific portion of the content that was consumed, and the type of content consumed (e.g., drama, comedy, children's, action, etc.). The usage information may also include usage characteristics for video data including but not limited to the duration that a video was played, the specific portion of the video that was played (e.g., as denoted by a time range or range of frames), and any other characteristics about the video playback.

In some cases, some users may be reluctant to provide personal or demographic information to various content publisher sites. However, these users may be amenable to providing this information to an independent ratings service, such as the ratings service described herein. First, if the user understands that their demographic and other user information need only be provided once in order to enable tracking of content consumption activity across multiple publisher sites, the user may appreciate this convenience and decide to opt-in. Second, the user may find the independent ratings service to be a trustworthy entity. For instance, the user may recognize that the independent ratings service implements certain privacy policies or privacy controls (e.g., using anonymized identifiers to store user information anonymously). In another example, the independent ratings service may be an entity that has built up a certain level of goodwill with the public and is therefore more likely to be trusted than a content publisher that has not established such goodwill. For at least these reasons, users may be amenable to sharing demographic information and/or other user information with the independent ratings service whereas they may not necessarily be comfortable sharing such information with content publishers.

FIG. 5 illustrates a flowchart of an example method for generating a content consumption report for a specific audience. In various embodiments, the illustrated method may be performed by one or more ratings servers implements an independent ratings service, such as ratings server(s) 130 including report generator 132 described above. In various embodiments, the illustrated method may be performed by a computer system, such as that of FIG. 6 described below.

As illustrated at block 500, the method may include determining characteristics of an audience. In various embodiments, these characteristics may be specified by a user desiring the report. In other cases, the characteristics may be parameters stored locally (e.g., on the rating server or another system). In various embodiments, such characteristics may include a specific demographic population. For instance, a non-limiting example of such characteristics might include all males between the ages of 18 and 32 living in the United States. Of course this is just one example of such characteristics. In general, any subset of demographic information may be specified as characteristics of an audience. For instance, different advertisers may be interested in different types of audiences for their products.

As illustrated at block 502, the method may include defining an audience as a subset of users having one or more of the characteristics. For instance, the method may include searching the records for all users that match the characteristics based on the user data collected (e.g., user data collected when the user opts-in to having their content consumption activities monitored/tracked). For instance, for the example above that specifies characteristics as being all males between the ages of 18 and 32 living in the United States, the method may include searching user information (e.g., user and usage data 150) for users meeting these characteristics; the results list of users may be defined as the audience for which a report is to be generated.

As illustrated at block 504, the method may also include generating a content consumption report based on collected usage information for users of the audience defined at block 502. In various embodiments, the report may specify aggregate attributes for the audience, such as what content or types of content the audience views most frequently. For instance, the report may specify a ranking of the most popular web videos viewed by users of the defined audience. In other examples, the report may be more general in that types of programming (e.g., sports, dramas, comedy, etc.) are ranked instead of specific content. As one non-limiting example, such a report might demonstrate that males between the ages of 18 and 32 living in the United States favor sports programming over drama series or children's shows. In general, the report may specific absolute and/or relative rankings for network-accessible content and/or types of network-accessible content. One example of a content consumption report includes content consumption report(s) 138 described above.

In various embodiments, the generated reports may be used by advertisers to select which network-based content should be pursued for advertising persons. For instance, if an advertiser is targeting a demographic including males between the ages of 18 and 32 living in the United States, the advertiser could use the example report described above to select network-based content (e.g., specific web videos) and/or types of network-based content (e.g., sports, comedy, etc.) in which to place advertisements (e.g., either in or proximate to the content). In various embodiments, the reports described herein may provide flexibility to advertisers as the reports may include content from multiple different content publishers. In this way, advertisers are not limited to using embodiments for placing advertisements within content provided by any specific content publisher.

### Example Computer System

Various embodiments of a system and method for rating audiences of network-based content of multiple content publishers, as described herein, may be executed on one or more computer systems, which may interact with various other devices. One such computer system is computer system 600 illustrated by FIG. 6, which may in various embodiments implement any of the systems, devices, elements or methods illustrated in FIGS. 1-5. For instance, any of the functionality described above with respect to the ratings server 130 or client system 100 may be stored in memory as processor-executable executable program instructions 622 (e.g., program instructions executable by processor(s) 610). In one non-limiting example, instructions 622 may implement browser 102 and/or script 126, as illustrated. In the illustrated embodiment, computer system 600 includes one or more processors 610 coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs), such as the x96, PowerPC, SPARC, or MIPS ISAs, or any other suitable ISA. In multiprocessor systems, each of processors 610 may commonly, but not necessarily, implement the same ISA.

System memory 620 may be configured to store program instructions 622 and/or data 632 accessible by processor 610. In various embodiments, program instructions 622 may be executable by the processor(s) to implement the functionality of any ratings server, client system, or any other component or system described above. In various embodiments, data 632 may store any of the data described above including but not limited to content 124. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the framework described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the computer system, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 685), such as other computer systems (e.g., content publisher system(s) 120 or ratings server(s) 130), or between nodes of computer system 600. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the process or methods described above, such as those of FIGS. 3-5. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, set top television boxes, pagers, and/or any other electronic device described herein. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Generally speaking, a computer-accessible medium may include a computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of methods may be changed, and various elements may be added, reordered, combined, omitted, modified, etc. Various modifications and changes may be made as would be obvious to a person skilled in the art having the benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A computer-implemented method, comprising:
for each of the plurality of users, receiving, by a ratings service, usage information specifying one or more attributes of the user's content consumption activity with respect to network-based content; wherein the user's content consumption activity comprises playing the network-based content within an application; wherein the usage information received for at least some of the users is associated with network-based content from multiple different content publishers; wherein the ratings service is independent from each of the multiple different content publishers;
determining, by the ratings service, a subset of the plurality of users that share one or more characteristics; and
generating, by the ratings service, a report based on a portion of the received usage information that is specific to the subset of the plurality of users; wherein the report specifies one or more aggregate attributes of the subset's content consumption activity.

2. The computer-implemented method of claim 1, wherein different portions of a given user's usage information are associated with content of different content publishers, wherein the method comprises identifying the usage information for the given user based on a common user identifier within the different portions of usage information.

3. The computer-implemented method of claim 2, wherein the user identifier is an identifier of a network browser cookie from a client device on which the given user consumed content.

4. The computer-implemented method of claim 1, wherein the one or more characteristics include one or more of a user's: age, gender, education level, location of residence, income, employment status, religion, marital status, property ownership, or known languages.

5. The computer-implemented method of claim 1, wherein the content consumption report includes a popularity ranking of content categories or content items consumed by the subset of the plurality of users.

6. The computer-implemented method of claim 1, wherein the content consumption report includes information specifying a sub-portion of a content item that is more popular than one or more other sub-portions of the content item.

7. The computer-implemented method of claim 1, wherein the method comprises receiving the usage information for the plurality of users subsequent to each of the plurality of users indicating that their content consumption activity is to be tracked.

8. A system, comprising:
a memory; and
one or more processors coupled to the memory, wherein the memory comprises program instructions executable by the one or more processors to implement an ratings service configured to:
for each of the plurality of users, receive usage information specifying one or more attributes of the user's content consumption activity with respect to network-based content; wherein the user's content consumption activity comprises playing the network-based content within an application; wherein the usage information received for at least some of the users is associated with network-based content from multiple different content publishers; wherein the ratings service is independent from each of the multiple different content publishers;
determine a subset of the plurality of users that share one or more characteristics; and
generate a report based on a portion of the received usage information that is specific to the subset of the plurality of users; wherein the report specifies one or more aggregate attributes of the subset's content consumption activity.

9. The system of claim 8, wherein different portions of a given user's usage information are associated with content of different content publishers, wherein the program instructions are configured to identify the usage information for the given user based on a common user identifier within the different portions of usage information.

10. The system of claim 9, wherein the user identifier is an identifier of a network browser cookie from a client device on which the given user consumed content.

11. The system of claim 8, wherein the one or more characteristics include one or more of a user's: age, gender, education level, location of residence, income, employment status, religion, marital status, property ownership, or known languages.

12. The system of claim 8, wherein the content consumption report includes a popularity ranking of content categories or content items consumed by the subset of the plurality of users.

13. The system of claim 8, wherein the content consumption report includes information specifying a sub-portion of a content item that is more popular than one or more other sub-portions of the content item.

14. The system of claim 8, wherein the program instructions are configured to receive the usage information for the plurality of users subsequent to each of the plurality of users indicating that their content consumption activity is to be tracked.

15. A computer-readable storage medium, storing program instructions computer-executable to implement an ratings service configured to:
for each of the plurality of users, receive usage information specifying one or more attributes of the user's content consumption activity with respect to network-based content; wherein the user's content consumption activity comprises playing the network-based content within an application;
wherein the usage information received for at least some of the users is associated with network-based content from multiple different content publishers; wherein the ratings service is independent from each of the multiple different content publishers;
determine a subset of the plurality of users that share one or more characteristics; and
generate a report based on a portion of the received usage information that is specific to the subset of the plurality of users; wherein the report specifies one or more aggregate attributes of the subset's content consumption activity.

16. The system of claim 15, wherein different portions of a given user's usage information are associated with content of different content publishers, wherein the program instructions are configured to identify the usage information for the given user based on a common user identifier within the different portions of usage information.

17. The system of claim 16, wherein the user identifier is an identifier of a network browser cookie from a client device on which the given user consumed content.

18. The system of claim 15, wherein the one or more characteristics include one or more of a user's: age, gender, education level, location of residence, income, employment status, religion, marital status, property ownership, or known languages.

19. The system of claim 15, wherein the content consumption report includes a popularity ranking of content categories or content items consumed by the subset of the plurality of users.

20. The system of claim 15, wherein the content consumption report includes information specifying a sub-portion of a content item that is more popular than one or more other sub-portions of the content item.

21. The system of claim 15, wherein the program instructions are configured to receive the usage information for the plurality of users subsequent to each of the plurality of users indicating that their content consumption activity is to be tracked.
